(19) United States
(12) Patent Application Publication
(10) Pub. No.: US 2021/0145026 A1
(43) Pub. Date: May 20, 2021

(54) COMPOSITION

(71) Applicant: SUNTORY HOLDINGS LIMITED, Osaka (JP)

(72) Inventors: Akinori ITOYAMA, Kanagawa (JP); Yoji ASAMI, Kanagawa (JP); Akiko FUJIE, Kanagawa (JP); Shigeru SARADA, Kanagawa (JP)

(73) Assignee: SUNTORY HOLDINGS LIMITED, Osaka (JP)

(21) Appl. No.: 16/772,464

(22) PCT Filed: Dec. 6, 2019
(86) PCT No.: PCT/JP2019/048839

§ 371 Date: Jun. 12, 2020

(30) Foreign Application Priority Data
Dec. 7, 2018 (JP) 2018-230148
Feb. 28, 2019 (JP) 2019-036285

(51) Int. Cl. A23L 2/60; A23L 2/68; A23L 2/38; A23L 2/58

(52) U.S. Cl. CPC A23L 2/60; A23L 2/58; A23L 2/38; A23L 2/68

(57) ABSTRACT

The present invention provides beverage compositions comprising rebaudioside M (Reb M) which have a surprising thirst-quenching effect. These compositions are particularly suitable for use in achieving and or maintaining thirst relief. For example, they may be particular beneficial in the area of sports drinks.

### FIELD OF THE INVENTION

The present invention relates to sweetened beverage compositions which provide an improved thirst quenching effect. These compositions comprise the steviol glycoside rebaudioside M (Reb M). The present invention also provides method to improve the thirst quenching effect of a beverage composition.

### BACKGROUND TO THE INVENTION

Sweeteners are used in beverages to impart a pleasant sweet taste. However, the use of caloric sweeteners such as sucrose, glucose fructose etc. has been linked to a wide array of health concerns. In particular obesity, diabetes, high cholesterol, tooth decay etc. have been linked to high sugar consumption. The use of these carbohydrate based sweeteners in soft drinks has been seen as a major contributor to the obesity epidemic as they provide calories but do not have a satiating effect.

The present inventors have also found that although beverages containing carbohydrate based sweeteners do provide some thirst-quenching effect when consumed, the level of thirst rises quickly afterwards. Within 2 hours of consuming the high sugar drink the level of thirst actually rises to above the initial baseline thirst level.

The sensation of thirst plays an important role in the consumption of water or other fluids to rehydrate the body in order to keep bodily functions working properly. The sensation of thirst can be alleviated by causing an increase in saliva secretion and wetting the mouth by ingestion of liquids even before absorption of fluids by the body. However, as discussed above, the presence of carbohydrate based sweeteners in a beverage results in a less thirst quenching drink wherein the level of thirstiness increases quickly after drinking. Therefore, the likelihood of a consumer drinking another high sugar drink after the first is increased, which can contribute to negative health effects such as obesity and diabetes. Therefore there is a need to develop beverage compositions with high thirst-quenching ability.

It was investigated whether alternative sweeteners could be used to provide a more thirst-quenching beverage. A number of rebaudiosides were assessed for their effect of thirst quenching. Rebaudiosides are a type of steviol glycosides, these compounds are found in the leaves of the plant Stevia rebaudiana. This plant is a perennial shrub of the Asteraceae (Compositae) family which is native to certain regions of South America. The leaves of the plant have been used for hundreds of years to sweeten tea and in traditional medicines. Crude stevia extracts were first commercialised as sweeteners in Japan in the early 1970s and the stevia plant is commercially cultivated in parts of Asia and South America.

To date a large number of different sweet tasting steviol glycosides have been identified and characterised. The compounds all contain a common aglycone steviol (ent-13-hydroxykaur-16-en-19-oic acid) shown in FIG. 1. The steviol glycosides then differ in the number and type of sugars which are attached at positions C13 (R²) and C19 (R¹).

| | | | Sweetness |
|---|---|---|---|
| | R groups on steviol | | potency (relative |
| Compound | R¹ | R² | to sucrose) |
| Rebaudioside A | β-glc- | (β-glc-)₂- | 200-300 |
| | | β-glc- | |
| Rebaudioside B | H | (β-glc-)₂- | 150 |
| | | β-glc- | |
| Rebaudioside C | β-glc- | (β-glc, α-rha)- | 30 |
| | | β-glc- | |
| Rebaudioside D | β-glc- β-glc- | (β-glc-)₂- | 221 |
| | | β-glc- | |
| Rebaudioside E | β-glc- β-glc- | β-glc- β-glc- | 174 |
| Rebaudioside F | β-glc- | (β-glc, β-xyl)- | 200 |
| | | β-glc- | |
| Rebaudioside M | (β-glc-)₂- | (β-glc-)₂- | 200-250 |
| | β-glc- | β-glc- | |
| Rubusoside | β-glc- | β-glc- | 114 |
| Steviolbioside | H | β-glc- β-glc- | 90 |
| Stevioside | β-glc- | β-glc- β-glc- | 150-250 |

Out of the rebaudiosides, Reb A is found in a high abundance and has sweetness more than 200 times that of sucrose. Further, the minor rebaudioside M (Reb M) has recently been identified as a high potency sweetener with a clean sweet taste and minimal aftertaste.

The water in the body contains dissolved minerals called electrolytes. They include sodium, potassium, and calcium. The body must also keep levels of electrolytes in balance and relatively constant. The balance of electrolytes is closely tied to the balance of water in the body: If one changes, the other usually also changes. In particular, the maintenance of precise osmotic gradients of electrolytes is important. Such gradients affect and regulate the hydration of the body as well as blood pH, and are critical for nerve and muscle function. Various mechanisms exist in living species that keep the concentrations of different electrolytes under tight control. Both muscle tissue and neurons are considered electric tissues of the body. Muscles and neurons are activated by electrolyte activity between the extracellular fluid or interstitial fluid, and intracellular fluid. Electrolytes may enter or leave the cell membrane through specialized protein structures embedded in the plasma membrane called ion channels. For example, muscle contraction is dependent upon the presence of calcium (Ca²⁺), sodium (Na⁺), and potassium (K⁺). Without sufficient levels of these key electrolytes, muscle weakness or severe muscle contractions may occur.

### SUMMARY OF THE INVENTION

Both Reb A and Reb M were investigated for their effect on thirst compared to HFCS. It was found that the components of the beverage can affect the level of thirst-quenching that is delivered. Surprisingly, beverages comprising Reb M were significantly more thirst-quenching compared to high fructose corn syrup (HFCS) or other rebaudioside sweeteners such as Reb A.

Therefore, Reb M may be particularly useful in beverage products to alleviate thirst in daily life, as well as in situations wherein quick hydration is required such as during exercise. Further, Reb M may be useful for beverages in a clinical setting wherein a patient requires fluid restriction. In this setting highly thirst-quenching beverages are particular beneficial for patient quality of life.

The present invention aims to provide beverage compositions with an improved thirst-quenching effect and methods for improving the thirst-quenching effect of beverages

The data presented herein has surprisingly shown that beverages comprising Reb M are more effective than both Reb A and HFCS at quenching thirst both immediately after consumption and at maintaining the quenching effect over time. It has also been demonstrated that the addition of Reb M to a beverage comprising HFCS can improve the thirst-quenching effect almost to the same level as a beverage containing Reb M alone. As such these beverages comprising a combination of Reb M and HFCS are more satisfying in terms of thirst. This means that a consumer is less likely to consume another sugar based drink shortly afterwards. These beverages also have the added benefit that a portion of the calories is reduced compared to a full HFCS drink, since Reb M is a low-calorie sweetener.

As such, a first aspect of the invention is a beverage composition comprising Reb M in a concentration from 150 ppm to 400 ppm and HFCS in an amount from 2.0 to 10.0 wt % based on the total weight of the beverage composition, wherein the weight ratio of Reb M:HFCS is from 1:50 to 1:660.

Further, as Reb M has been shown to have an excellent thirst-quenching effect, it is ideal for use in sports drinks wherein excellent thirst-quenching and rehydration properties are highly desirable. As such a second aspect of the invention is a beverage composition comprising Reb M in a concentration from 100 to 500 ppm and sodium at a concentration from 20 to 70 mg/100 mL and wherein the pH is from pH 2.5 to 4.0.

A third aspect of the invention is a beverage according to the first or second aspect for use in achieving and/or maintaining thirst relief.

### BRIEF DESCRIPTION OF THE DRAWINGS

FIG. 1 shows the core aglycone steviol moiety that is common between all rebaudiosides. The rebaudiosides vary in terms of the sugar moieties that are attached at C13 and C19.

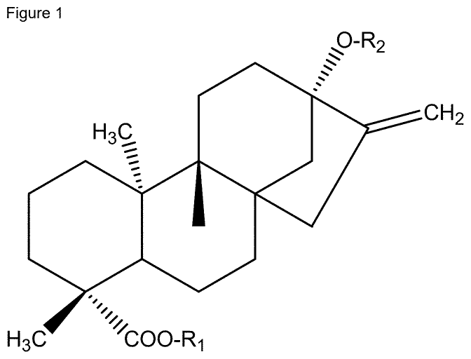

FIG. 2 shows the structure of rebaudioside M (Reb M).

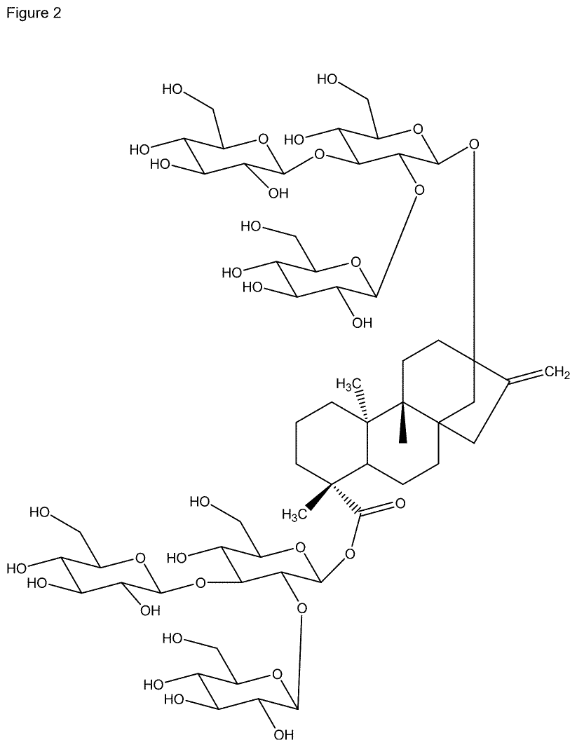

FIG. 3 shows the structure of rebaudioside D (Reb D).

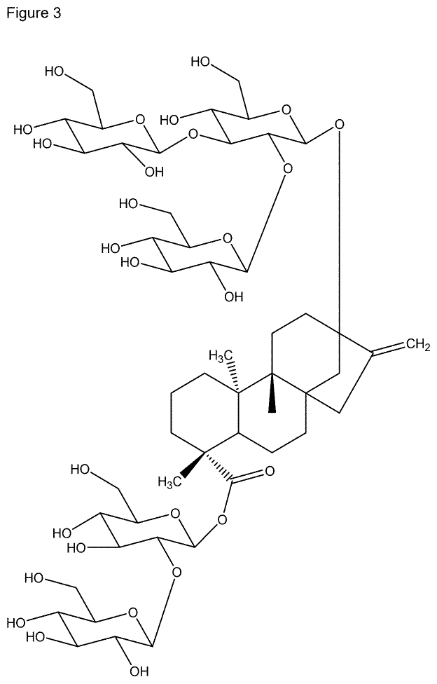

FIG. 4 shows the consumer thirst test for 0.05% Reb M, 0.05% Reb A and 13.3% HFCS beverage samples. The level of thirst was assessed immediately after drinking the beverage, 30 minutes, 1 hour and 2 hours after drinking.

FIG. 5 shows the consumer thirst test for 0.05% Reb A, 13.3% HFCS, 5.3% HFCS+0.02% Reb A and 8.0% HFCS+0.03% Reb A beverage samples. The level of thirst was assessed immediately after drinking the beverage, 30 minutes, 1 hour and 2 hours after drinking.

FIG. 6 shows the consumer thirst test for 0.05% Reb M, 13.3% HFCS, 5.3% HFCS+0.02% Reb M and 8.0% HFCS+0.03% Reb M beverage samples. The level of thirst was assessed immediately after drinking the beverage, 30 minutes, 1 hour and 2 hours after drinking.

FIG. 7 shows the consumer rating of the taste of each beverage sample in terms of initial overall liking and overall liking.

FIG. 8 shows the consumer thirst test for 0.05% Reb M+50 mg/100 mL sodium, 0.05% Reb A+50 mg/100 mL sodium and 13.3% HFCS+50 mg/100 mL sodium beverage samples. The level of thirst was assessed immediately after drinking the beverage, 30 minutes, 1 hour and 2 hours after drinking

### DETAILED DESCRIPTION

The present invention provides beverage compositions comprising Reb M wherein the thirst-quenching effect of the beverage is improved. Thirst plays a key role in the regulation of body-fluid homeostasis by motivating an individual to seek constant supplies of water and sodium to maintain fluid balance. As used herein the term “thirst-quenching” refers to the effect of relieving thirst or stopping the feeling of thirst.

It has been shown herein that drinks comprising HFCS as the sole sweetener do not provide as effective thirst-quenching as beverages with Reb M. The HFCS beverage also resulted in consumers becoming more thirsty two hours after drinking the beverage than they had been before drinking the beverage. This effect can result in consumers drinking more of high sugar drinks and therefore ingesting more calories. High calorie and high sugar diets can contribute to weight gain and conditions such as type II diabetes. However, it has surprisingly been found that by combining HFCS with Reb M a more thirst-quenching beverage can be produced. These beverages are more effective at quenching thirst and maintaining the quenched effect.

Therefore a first aspect of the invention is a beverage composition comprising Reb M in a concentration from 150 ppm to 400 ppm and HFCS in an amount from 2.0 to 10.0 wt % based on the total weight of the beverage composition, wherein the weight ratio of Reb M:HFCS is from 1:50 to 1:660. In an embodiment the Reb M is present in a concentration from 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 150 to 325 ppm, 175 to 325 ppm, 200 to 325 ppm, 225 to 325 ppm, 250 to 325 ppm, 275 to 325 ppm, 300 to 325 ppm, 150 to 300 ppm, 175 to 300 ppm, 200 to 300 ppm, 225 to 300 ppm, 250 to 300 ppm, 275 to 300 ppm, 150 to 275 ppm, 175 to 275 ppm, 200 to 275 ppm, 225 to 275 ppm, 250 to 275 ppm, 150 ppm to 250 ppm, 175 to 250 ppm, 200 to 250 ppm, 225 to 250 ppm, 150 to 225 ppm, 175 to 225 ppm, 200 to 225 ppm, 150 to 200 ppm, 175 to 200 ppm, or 150 to 175 ppm. Unless otherwise particularly described, all ppms described herein are by weight.

In an embodiment of the first aspect the beverage composition comprises HFCS in an amount from 2.0 to 10.0 wt %, 2.0 to 9.5 wt %, 2.0 to 9.0 wt %, 2.0 to 8.5 wt %, 2.0 to 8.0 wt %, 2.0 to 7.5 wt %, 2.0 to 7.0 wt %, 2.0 to 6.5 wt %, 2.0 to 6.0 wt %, 2.0 to 5.5 wt %, 2.0 to 5.0 wt %, 2.0 to 4.5 wt %, 2.0 to 4.0 wt %, 2.0 to 3.5 wt %, 2.0 to 3.0 wt %, 2.0 to 2.5 wt %, 2.5 to 10.0 wt %, 2.5 to 9.5 wt %, 2.5 to 9.0 wt %, 2.5 to 8.5 wt %, 2.5 to 8.0 wt %, 2.5 to 7.5 wt %, 2.5 to 7.0 wt %, 2.5 to 6.5 wt %, 2.5 to 6.0 wt %, 2.5 to 5.5 wt %, 2.5 to 5.0 wt %, 2.5 to 4.5 wt %, 2.5 to 4.0 wt %, 2.5 to 3.5 wt %, 2.5 to 3.0 wt %, 3.0 to 10.0 wt %, 3.0 to 9.5 wt %, 3.0 to 9.0 wt %, 3.0 to 8.5 wt %, 3.0 to 8.0 wt %, 3.0 to 7.5 wt %, 3.0 to 7.0 wt %, 3.0 to 6.5 wt %, 3.0 to 6.0 wt %, 3.0 to 5.5 wt %, 3.0 to 5.0 wt %, 3.0 to 4.5 wt %, 3.0 to 4.0 wt %, 3.0 to 3.5 wt %, 3.5 to 10.0 wt %, 3.5 to 9.5 wt %, 3.5 to 9.0 wt %, 3.5 to 8.5 wt %, 3.5 to 8.0 wt %, 3.5 to 7.5 wt %, 3.5 to 7.0 wt %, 3.5 to 6.5 wt %, 3.5 to 6.0 wt %, 3.5 to 5.5 wt %, 3.5 to 5.0 wt %, 3.5 to 4.5 wt %, 3.5 to 4.0 wt %, 4.0 to 10.0 wt %, 4.0 to 9.5 wt %, 4.0 to 9.0 wt %, 4.0 to 8.5 wt %, 4.0 to 8.0 wt %, 4.0 to 7.5 wt %, 4.0 to 7.0 wt %, 4.0 to 6.5 wt %, 4.0 to 6.0 wt %, 4.0 to 5.5 wt %, 4.0 to 5.0 wt %, 4.0 to 4.5 wt %, 4.5 to 10.0 wt %, 4.5 to 9.5 wt %, 4.5 to 9.0 wt %, 4.5 to 8.5 wt %, 4.5 to 8.0 wt %, 4.5 to 7.5 wt %, 4.5 to 7.0 wt %, 4.5 to 6.5 wt %, 4.5 to 6.0 wt %, 4.5 to 5.5 wt %, 4.5 to 5.0 wt %, 5.0 to 10.0 wt %, 5.0 to 9.5 wt %, 5.0 to 9.0 wt %, 5.0 to 8.5 wt %, 5.0 to 8.0 wt %, 5.0 to 7.5 wt %, 5.0 to 7.0 wt %, 5.0 to 6.5 wt %, 5.0 to 6.0 wt %, 5.0 to 5.5 wt %, 5.5 to 10.0 wt %, 5.5 to 9.5 wt %, 5.5 to 9.0 wt %, 5.5 to 8.5 wt %, 5.5 to 8.0 wt %, 5.5 to 7.5 wt %, 5.5 to 7.0 wt %, 5.5 to 6.5 wt %, 5.5 to 6.0 wt %, 6.0 to 10.0 wt %, 6.0 to 9.5 wt %, 6.0 to 9.0 wt %, 6.0 to 8.5 wt %, 6.0 to 8.0 wt %, 6.0 to 7.5 wt %, 6.0 to 7.0 wt %, 6.0 to 6.5 wt %, 6.5 to 10.0 wt %, 6.5 to 9.5 wt %, 6.5 to 9.0 wt %, 6.5 to 8.5 wt %, 6.5 to 8.0 wt %, 6.5 to 7.5 wt %, 6.5 to 7.0 wt %, 7.0 to 10.0 wt %, 7.0 to 9.5 wt %, 7.0 to 9.0 wt %, 7.0 to 8.5 wt %, 7.0 to 8.0 wt %, 7.0 to 7.5 wt %, 7.5 to 10.0 wt %, 7.5 to 9.5 wt %, 7.5 to 9.0 wt %, 7.5 to 8.5 wt %, 7.5 to 8.0 wt %, 8.0 to 10.0 wt %, 8.0 to 9.5 wt %, 8.0 to 9.0 wt %, 8.0 to 8.5 wt %, based on the total weight of the beverage composition, and Reb M in a concentration from 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 150 to 325 ppm, 175 to 325 ppm, 200 to 325 ppm, 225 to 325 ppm, 250 to 325 ppm, 275 to 325 ppm, 300 to 325 ppm, 150 to 300 ppm, 175 to 300 ppm, 200 to 300 ppm, 225 to 300 ppm, 250 to 300 ppm, 275 to 300 ppm, 150 to 275 ppm, 175 to 275 ppm, 200 to 275 ppm, 225 to 275 ppm, 250 to 275 ppm, 150 ppm to 250 ppm, 175 to 250 ppm, 200 to 250 ppm, 225 to 250 ppm, 150 to 225 ppm, 175 to 225 ppm, 200 to 225 ppm, 150 to 200 ppm, 175 to 200 ppm, or 150 to 175 ppm, wherein the weight ratio of Reb M:HFCS is from 1:50 to 1:660.

In an embodiment of the first aspect the beverage composition comprises HFCS in an amount from 2.0 to 8.0 wt % based on the total weight of the beverage composition, and Reb M in a concentration from 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 150 to 325 ppm, 175 to 325 ppm, 200 to 325 ppm, 225 to 325 ppm, 250 to 325 ppm, 275 to 325 ppm, 300 to 325 ppm, 150 to 300 ppm, 175 to 300 ppm, 200 to 300 ppm, 225 to 300 ppm, 250 to 300 ppm, 275 to 300 ppm, 150 to 275 ppm, 175 to 275 ppm, 200 to 275 ppm, 225 to 275 ppm, 250 to 275 ppm, 150 ppm to 250 ppm, 175 to 250 ppm, 200 to 250 ppm, 225 to 250 ppm, 150 to 225 ppm, 175 to 225 ppm, 200 to 225 ppm, 150 to 200 ppm, 175 to 200 ppm, or 150 to 175 ppm, wherein the weight ratio of Reb M:HFCS is from 1:50 to 1:533.

In an embodiment of the first aspect the beverage composition comprises HFCS in an amount from 2.0 to 6.0 wt % based on the total weight of the beverage composition, and Reb M in a concentration from 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 150 to 325 ppm, 175 to 325 ppm, 200 to 325 ppm, 225 to 325 ppm, 250 to 325 ppm, 275 to 325 ppm, 300 to 325 ppm, 150 to 300 ppm, 175 to 300 ppm, 200 to 300 ppm, 225 to 300 ppm, 250 to 300 ppm, 275 to 300 ppm, 150 to 275 ppm, 175 to 275 ppm, 200 to 275 ppm, 225 to 275 ppm, 250 to 275 ppm, 150 ppm to 250 ppm, 175 to 250 ppm, 200 to 250 ppm, 225 to 250 ppm, 150 to 225 ppm, 175 to 225 ppm, 200 to 225 ppm, 150 to 200 ppm, 175 to 200 ppm, or 150 to 175 ppm, wherein the weight ratio of Reb M:HFCS is from 1:50 to 1:400.

In an embodiment of the first aspect the beverage composition comprises HFCS in an amount from 6.5 to 8.5 wt % based on the total weight of the beverage composition, and Reb M in a concentration from 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 150 to 325 ppm, 175 to 325 ppm, 200 to 325 ppm, 225 to 325 ppm, 250 to 325 ppm, 275 to 325 ppm, 300 to 325 ppm, 150 to 300 ppm, 175 to 300 ppm, 200 to 300 ppm, 225 to 300 ppm, 250 to 300 ppm, 275 to 300 ppm, 150 to 275 ppm, 175 to 275 ppm, 200 to 275 ppm, 225 to 275 ppm, 250 to 275 ppm, 150 ppm to 250 ppm, 175 to 250 ppm, 200 to 250 ppm, 225 to 250 ppm, 150 to 225 ppm, 175 to 225 ppm, 200 to 225 ppm, 150 to 200 ppm, 175 to 200 ppm, or 150 to 175 ppm, wherein the weight ratio of Reb M:HFCS is from 1:162 to 1:566.

In a particular embodiment of the first aspect the beverage composition comprises Reb M in a concentration from 150 to 250 ppm and HFCS in an amount from 6.7 to 9.3 wt % based on the total weight of the beverage composition, wherein the weight ratio of Reb M:HFCS is from 1:268 to 1:620.

In a particular embodiment of the first aspect the beverage composition comprises Reb M in a concentration from 250 to 350 ppm and HFCS in an amount from 4.0 to 6.7 wt % based on the total weight of the beverage composition, wherein the weight ratio of Reb M:HFCS is from 1:114 to 1:268.

In an embodiment of the first aspect of the invention the weight ratio of Reb M:HFCS is from 1:50 to 1:660, 1:50 to 1:600, 1:50 to 1:550, 1:50 to 1:500, 1:50 to 1:450, 1:50 to 1:400. 1:50 to 1:350, 1:50 to 1:300, 1:50 to 1:250, 1:50 to 1:200, 1:50 to 1:150, 1:50 to 1:100, 1:100 to 1:660, 1:100 to 1:600, 1:100 to 1:550, 1:100 to 1:500, 1:100 to 1:450, 1:100 to 1:400, 1:100 to 1:350, 1:100 to 1:300, 1:100 to 1:250, 1:100 to 1:200, 1:100 to 1:150, 1:150 to 1:660, 1:150 to 1:600, 1:150 to 1:550, 1:150 to 1:500, 1:150 to 1:450, 1:150 to 1:400, 1:150 to 1:350, 1:150 to 1:300, 1:150 to 1:250, 1:150 to 1:200, 1:200 to 1:660, 1:200 to 1:600, 1:200 to 1:550, 1:200 to 1:500, 1:200 to 1:450, 1:200 to 1:400, 1:200 to 1:350, 1:200 to 1:300, 1:200 to 1:250, 1:250 to 1:660, 1:250 to 1:600, 1:250 to 1:550, 1:250 to 1:500, 1:250 to 1:450, 1:250 to 1:400, 1:250 to 1:350, 1:250 to 1:300, 1:300 to 1:660, 1:300 to 1:600, 1:300 to 1:550, 1:300 to 1:500, 1:300 to 1:450, 1:300 to 1:400, 1:300 to 1:350, 1:350 to 1:660, 1:350 to 1:600, 1:350 to 1:550, 1:350 to 1:500, 1:350 to 1:450, 1:350 to 1:400, 1:400 to 1:660, 1:400 to 1:600, 1:400 to 1:550, 1:400 to 1:500, 1:400 to 1:450, 1:450 to 1:660, 1:450 to 1:600, 1:450 to 1:550, 1:450 to 1:500, 1:500 to 1:660, 1:500 to 1:600, 1:500 to 1:550, 1:550 to 1:660, 1:550 to 1:600, or 1:600 to 1:660.

In an embodiment of the first aspect of the present invention the pH of the beverage composition is from pH 2 to 5, pH 2.2 to 5, pH 2.4 to 5, pH 2.6 to 5, pH 2.8 to 5, pH 3.0 to 5, pH 3.5 to 5, pH 2 to 4.5, pH 2.2 to 4.5, pH 2.4 to 4.5, pH 2.6 to 4.5, pH 2.8 to 4.5, pH 3 to 4.5, pH 3.5 to 4.5, pH 2 to 4, pH 2.2 to 4, pH 2.4 to 4, pH 2.6 to 4, pH 2.8 to 4, pH 3 to 4, pH 3.5 to 4, pH 2 to 3.5, pH 2.2 to 3.5, pH 2.4 to 3.5, pH 2.6 to 3.5, pH 2.8 to 3.5, pH 3.0 to 3.5. Preferably the pH is in the range from pH 2.5 to 3.5.

The data presented herein has demonstrated that beverages comprising Reb M have an enhanced thirst quenching effect and maintain this effect over a two hour period after drinking. Therefore, it has surprisingly been found that there are clear advantages to using Reb M in beverage compositions wherein a thirst quenching effect is desirable such as sports drinks or beverages used in a clinical setting for patients on a fluid restricted diet.

As such a second aspect of the invention is a beverage composition comprising Reb M in a concentration from 100 to 500 ppm and sodium in a concentration from to 70 mg/100 mL and wherein the pH is from pH 2 to 4. In an embodiment of the second aspect of the present invention the beverage composition comprises Reb M in a concentration from 100 to 500 ppm, 125 to 500 ppm, 150 to 500 ppm, 175 to 500 ppm, 200 to 500 ppm, 225 to 500 ppm, 250 to 500 ppm, 275 to 500 ppm, 300 to 500 ppm, 325 to 500 ppm, 350 to 500 ppm, 375 to 500 ppm, 400 to 500 ppm, 425 to 500 ppm, 450 to 500 ppm, 475 to 500 ppm, 100 to 475 ppm, 125 to 475 ppm, 150 to 475 ppm, 175 to 475 ppm, 200 to 475 ppm, 225 to 475 ppm, 250 to 475 ppm, 275 to 475 ppm, 300 to 475 ppm, 325 to 475 ppm, 350 to 475 ppm, 375 to 475 ppm, 400 to 475 ppm, 425 to 475 ppm, 450 to 475 ppm, 100 to 450 ppm, 125 to 450 ppm, 150 to 450 ppm, 175 to 450 ppm, 200 to 450 ppm, 225 to 450 ppm, 250 to 450 ppm, 275 to 450 ppm, 300 to 450 ppm, 325 to 450 ppm, 350 to 450 ppm, 375 to 450 ppm, 400 to 450 ppm, 425 to 450 ppm, 100 to 425 ppm, 125 to 425 ppm, 150 to 425 ppm, 175 to 425 ppm, 200 to 425 ppm, 225 to 425 ppm, 250 to 425 ppm, 275 to 425 ppm, 300 to 425 ppm, 325 to 425 ppm, 350 to 425 ppm, 375 to 425 ppm, 400 to 425 ppm, 100 to 400 ppm, 125 to 400 ppm 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 100 to 365 ppm, 125 to 375 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 100 to 350 ppm, 125 to 350 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 100 to 325 ppm, 125 to 325 ppm, 150 to 325 ppm, 175 to 325 ppm, 200 to 325 ppm, 225 to 325 ppm, 250 to 325 ppm, 275 to 325 ppm, 300 to 325 ppm, 100 to 300 ppm, 125 to 300 ppm, 150 to 300 ppm, 175 to 300 ppm, 200 to 300 ppm, 225 to 300 ppm, 250 to 300 ppm, 275 to 300 ppm, 100 to 275 ppm, 125 to 275 ppm, 150 to 275 ppm, 175 to 275 ppm, 200 to 275 ppm, 225 to 275 ppm, 250 to 275 ppm, 100 to 250 ppm, 125 to 250 ppm, 150 ppm to 250 ppm, 175 to 250 ppm, 200 to 250 ppm, 225 to 250 ppm, 100 to 225 ppm, 125 to 225 ppm, 150 to 225 ppm, 175 to 225 ppm, 200 to 225 ppm, 100 to 200 ppm, 125 to 200 ppm, 150 to 200 ppm, 175 to 200 ppm, or 150 to 175 ppm.

In an embodiment of the second aspect the beverage composition comprises sodium in a concentration from 30 to 60 mg/100 mL and Reb M in a concentration from 100 to 500 ppm, 125 to 500 ppm, 150 to 500 ppm, 175 to 500 ppm, 200 to 500 ppm, 225 to 500 ppm, 250 to 500 ppm, 275 to 500 ppm, 300 to 500 ppm, 325 to 500 ppm, 350 to 500 ppm, 375 to 500 ppm, 400 to 500 ppm, 425 to 500 ppm, 450 to 500 ppm, 475 to 500 ppm, 100 to 475 ppm, 125 to 475 ppm, 150 to 475 ppm, 175 to 475 ppm, 200 to 475 ppm, 225 to 475 ppm, 250 to 475 ppm, 275 to 475 ppm, 300 to 475 ppm, 325 to 475 ppm, 350 to 475 ppm, 375 to 475 ppm, 400 to 475 ppm, 425 to 475 ppm, 450 to 475 ppm, 100 to 450 ppm, 125 to 450 ppm, 150 to 450 ppm, 175 to 450 ppm, 200 to 450 ppm, 225 to 450 ppm, 250 to 450 ppm, 275 to 450 ppm, 300 to 450 ppm, 325 to 450 ppm, 350 to 450 ppm, 375 to 450 ppm, 400 to 450 ppm, 425 to 450 ppm, 100 to 425 ppm, 125 to 425 ppm, 150 to 425 ppm, 175 to 425 ppm, 200 to 425 ppm, 225 to 425 ppm, 250 to 425 ppm, 275 to 425 ppm, 300 to 425 ppm, 325 to 425 ppm, 350 to 425 ppm, 375 to 425 ppm, 400 to 425 ppm, 100 to 400 ppm, 125 to 400 ppm 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 100 to 365 ppm, 125 to 375 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 100 to 350 ppm, 125 to 350 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 100 to 325 ppm, 125 to 325 ppm, 150 to 325 ppm, 175 to 325 ppm, 200 to 325 ppm, 225 to 325 ppm, 250 to 325 ppm, 275 to 325 ppm, 300 to 325 ppm, 100 to 300 ppm, 125 to 300 ppm, 150 to 300 ppm, 175 to 300 ppm, 200 to 300 ppm, 225 to 300 ppm, 250 to 300 ppm, 275 to 300 ppm, 100 to 275 ppm, 125 to 275 ppm, 150 to 275 ppm, 175 to 275 ppm, 200 to 275 ppm, 225 to 275 ppm, 250 to 275 ppm, 100 to 250 ppm, 125 to 250 ppm, 150 ppm to 250 ppm, 175 to 250 ppm, 200 to 250 ppm, 225 to 250 ppm, 100 to 225 ppm, 125 to 225 ppm, 150 to 225 ppm, 175 to 225 ppm, 200 to 225 ppm, 100 to 200 ppm, 125 to 200 ppm, 150 to 200 ppm, 175 to 200 ppm, or 150 to 175 ppm, and the pH is from pH 2 to 4.

In an embodiment of the second aspect the beverage composition comprises sodium in a concentration from 35 to 55 mg/100 mL and Reb M in a concentration from 100 to 500 ppm, 125 to 500 ppm, 150 to 500 ppm, 175 to 500 ppm, 200 to 500 ppm, 225 to 500 ppm, 250 to 500 ppm, 275 to 500 ppm, 300 to 500 ppm, 325 to 500 ppm, 350 to 500 ppm, 375 to 500 ppm, 400 to 500 ppm, 425 to 500 ppm, 450 to 500 ppm, 475 to 500 ppm, 100 to 475 ppm, 125 to 475 ppm, 150 to 475 ppm, 175 to 475 ppm, 200 to 475 ppm, 225 to 475 ppm, 250 to 475 ppm, 275 to 475 ppm, 300 to 475 ppm, 325 to 475 ppm, 350 to 475 ppm, 375 to 475 ppm, 400 to 475 ppm, 425 to 475 ppm, 450 to 475 ppm, 100 to 450 ppm, 125 to 450 ppm, 150 to 450 ppm, 175 to 450 ppm, 200 to 450 ppm, 225 to 450 ppm, 250 to 450 ppm, 275 to 450 ppm, 300 to 450 ppm, 325 to 450 ppm, 350 to 450 ppm, 375 to 450 ppm, 400 to 450 ppm, 425 to 450 ppm, 100 to 425 ppm, 125 to 425 ppm, 150 to 425 ppm, 175 to 425 ppm, 200 to 425 ppm, 225 to 425 ppm, 250 to 425 ppm, 275 to 425 ppm, 300 to 425 ppm, 325 to 425 ppm, 350 to 425 ppm, 375 to 425 ppm, 400 to 425 ppm, 100 to 400 ppm, 125 to 400 ppm 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 100 to 365 ppm, 125 to 375 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 100 to 350 ppm, 125 to 350 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 100 to 325 ppm, 125 to 325 ppm, 150 to 325 ppm, 175 to 325 ppm, 200 to 325 ppm, 225 to 325 ppm, 250 to 325 ppm, 275 to 325 ppm, 300 to 325 ppm, 100 to 300 ppm, 125 to 300 ppm, 150 to 300 ppm, 175 to 300 ppm, 200 to 300 ppm, 225 to 300 ppm, 250 to 300 ppm, 275 to 300 ppm, 100 to 275 ppm, 125 to 275 ppm, 150 to 275 ppm, 175 to 275 ppm, 200 to 275 ppm, 225 to 275 ppm, 250 to 275 ppm, 100 to 250 ppm, 125 to 250 ppm, 150 ppm to 250 ppm, 175 to 250 ppm, 200 to 250 ppm, 225 to 250 ppm, 100 to 225 ppm, 125 to 225 ppm, 150 to 225 ppm, 175 to 225 ppm, 200 to 225 ppm, 100 to 200 ppm, 125 to 200 ppm, 150 to 200 ppm, 175 to 200 ppm, or 150 to 175 ppm, and the pH is from pH 2 to 4.

In an embodiment of the second aspect the beverage composition comprises sodium in a concentration from 35 to 45 mg/100 mL and Reb M in a concentration from 100 to 500 ppm, 125 to 500 ppm, 150 to 500 ppm, 175 to 500 ppm, 200 to 500 ppm, 225 to 500 ppm, 250 to 500 ppm, 275 to 500 ppm, 300 to 500 ppm, 325 to 500 ppm, 350 to 500 ppm, 375 to 500 ppm, 400 to 500 ppm, 425 to 500 ppm, 450 to 500 ppm, 475 to 500 ppm, 100 to 475 ppm, 125 to 475 ppm, 150 to 475 ppm, 175 to 475 ppm, 200 to 475 ppm, 225 to 475 ppm, 250 to 475 ppm, 275 to 475 ppm, 300 to 475 ppm, 325 to 475 ppm, 350 to 475 ppm, 375 to 475 ppm, 400 to 475 ppm, 425 to 475 ppm, 450 to 475 ppm, 100 to 450 ppm, 125 to 450 ppm, 150 to 450 ppm, 175 to 450 ppm, 200 to 450 ppm, 225 to 450 ppm, 250 to 450 ppm, 275 to 450 ppm, 300 to 450 ppm, 325 to 450 ppm, 350 to 450 ppm, 375 to 450 ppm, 400 to 450 ppm, 425 to 450 ppm, 100 to 425 ppm, 125 to 425 ppm, 150 to 425 ppm, 175 to 425 ppm, 200 to 425 ppm, 225 to 425 ppm, 250 to 425 ppm, 275 to 425 ppm, 300 to 425 ppm, 325 to 425 ppm, 350 to 425 ppm, 375 to 425 ppm, 400 to 425 ppm, 100 to 400 ppm, 125 to 400 ppm 150 to 400 ppm, 175 to 400 ppm, 200 to 400 ppm, 225 to 400 ppm, 250 to 400 ppm, 275 to 400 ppm, 300 to 400 ppm, 325 to 400 ppm, 350 to 400 ppm, 375 to 400 ppm, 100 to 365 ppm, 125 to 375 ppm, 150 to 375 ppm, 175 to 375 ppm, 200 to 375 ppm, 225 to 375 ppm, 250 to 375 ppm, 275 to 375 ppm, 300 to 375 ppm, 325 to 375 ppm, 350 to 375 ppm, 100 to 350 ppm, 125 to 350 ppm, 150 to 350 ppm, 175 to 350 ppm, 200 to 350 ppm, 225 to 350 ppm, 250 to 350 ppm, 275 to 350 ppm, 300 to 350 ppm, 325 to 350 ppm, 100 to 325 ppm, 125 to 325 ppm, 150 to 325 ppm, 175 to 325 ppm, 200 to 325 ppm, 225 to 325 ppm, 250 to 325 ppm, 275 to 325 ppm, 300 to 325 ppm, 100 to 300 ppm, 125 to 300 ppm, 150 to 300 ppm, 175 to 300 ppm, 200 to 300 ppm, 225 to 300 ppm, 250 to 300 ppm, 275 to 300 ppm, 100 to 275 ppm, 125 to 275 ppm, 150 to 275 ppm, 175 to 275 ppm, 200 to 275 ppm, 225 to 275 ppm, 250 to 275 ppm, 100 to 250 ppm, 125 to 250 ppm, 150 ppm to 250 ppm, 175 to 250 ppm, 200 to 250 ppm, 225 to 250 ppm, 100 to 225 ppm, 125 to 225 ppm, 150 to 225 ppm, 175 to 225 ppm, 200 to 225 ppm, 100 to 200 ppm, 125 to 200 ppm, 150 to 200 ppm, 175 to 200 ppm, or 150 to 175 ppm, and the pH is from pH 2 to 4.

In an embodiment of the second aspect of the invention the beverage composition may comprise sodium in a concentration from 20 to 70 mg/100 mL, 30 to 70 mg/100 mL, 40 to 70 mg/100 mL, 20 to 65 mg/100 mL, 30 to 65 mg/100 mL, 40 to 65 mg/100 mL, 20 to 60 mg/100 mL, 30 to 60 mg/100 mL, 40 to 60 mg/100 mL, 20 to 55 mg/100 mL, 30 to 55 mg/100 mL, 40 to 55 mg/100 mL, 20 to 50 mg/100 mL, to 50 mg/100 mL, 40 to 50 mg/100 mL, 20 to 45 mg/100 mL, 25 to 45 mg/100 mL, to 45 mg/100 mL, 35 to 45 mg/100 mL.

In an embodiment of the second aspect of the present invention the pH of the beverage composition is from pH 2 to 4, pH 2.2 to 4, pH 2.4 to 4, pH 2.6 to 4, pH 2.8 to 4, pH 3.0 to 4, pH 3.5 to 4, pH 2 to 3.8, pH 2.2 to 3.8, pH 2.4 to 3.8, pH 2.6 to 3.8, pH 2.8 to 3.8, pH 3 to 3.8, pH 3.5 to 3.8, pH 2 to 3.5, pH 2.2 to 3.5, pH 2.4 to 3.5, pH 2.6 to 3.5, pH 2.8 to 3.5, pH 3 to 3.5, pH 2 to 3.2, pH 2.2 to 3.2, pH 2.4 to 3.2, pH 2.6 to 3.2, pH 2.8 to 3.2, pH 3.0 to 3.2. Preferably the pH is in the range from pH 2.5 to 3.5.

The beverage according to the second aspect may be a sports drink. As used herein the term “sports drink” may refer to a thirst-quenching beverage used in sports and related activities, to rehydrate, boost energy and replenish electrolytes lost to sweating. Sports drinks may be classified as isotonic drinks, carbohydrate drinks or protein drinks. Isotonic drinks may comprise additional electrolytes to replace those lost during exercise. Carbohydrate drinks may comprise additional sugars such as glucose to help replenish energy reserves. Protein drinks may comprise amino acids to help recuperate fatigued muscles.

The source of the sodium used in the second aspect of the invention is preferably sodium chloride.

In an embodiment of the second aspect of the invention the beverage composition comprises additional electrolytes such as potassium, chloride, calcium, magnesium, bicarbonate or phosphates. In some embodiments, the electrolytes are obtained from their corresponding water-soluble salts. Non-limiting examples of salts for use in particular embodiments include chlorides, carbonates, sulfates, acetates, bicarbonates, citrates, phosphates, hydrogen phosphates, tartates, sorbates, citrates, benzoates, or combinations thereof.

Where potassium is also used in the second aspect of the invention, its source is preferably potassium chloride.

The beverage composition according the second aspect may also comprise amino acid such as, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-α-lysine or poly-L-ε-lysine), poly-L-ornithine, poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). In particular embodiments, the amino acid is present in the sweetener composition in an amount effective to provide a concentration from about 10 ppm to about 50,000 ppm when present in a sweetened composition, such as, for example, a beverage. In another embodiment, the amino acid is present in the sweetener composition in an amount effective to provide a concentration from about 1,000 ppm to about 10,000 ppm when present in a sweetened composition, such as, for example, from about 2,500 ppm to about 5,000 ppm or from about 250 ppm to about 7,500 ppm.

In beverage it is preferable that a buffer system is used. Suitable buffer systems of use in the present invention include, by way of example only, tartaric, fumaric, maleic, phosphoric, and acetic acids and salts. Preferred buffering systems include citric acid and phosphoric acid buffer systems. The most preferred buffer system is a citric acid buffer system preferably contains sodium citrate in combination with citric acid. Preferably there is about 0.1 to about 10 grams/litre of sodium citrate, and about 0.05 to about 5 grams/litre of citric acid. Typically suitable buffer systems include those capable of maintaining a pH in the range stated in the embodiments herein.

In an embodiment of the first and second aspects the beverage composition may be carbonated. As used herein a “carbonated beverage” is a beverage that contains carbon dioxide gas (CO₂). The presence of the CO₂ produces bubbles within the beverage.

In an embodiment of the first and second aspects the carbonated beverage may comprise carbon dioxide (CO₂) at a gas pressure from 1.0-3.5 kg/m³. Preferably the CO₂ is at a gas pressure from 1.5-3.0 kg/m³, more preferably the CO₂ is at a gas pressure from 2.0-3.0 kg/m³.

In another embodiment of the first and second aspects the carbonated beverage may comprise carbon dioxide (CO₂) at a gas pressure from 1.0-3.5 kgf/cm². Preferably the CO₂ is at a gas pressure from 1.5-3.0 kgf/cm², more preferably the CO₂ is at a gas pressure from 2.0-3.0 kgf/cm².

The beverage composition according to the first or second aspect of the present invention may comprise Reb M as the primary sweetening component. The beverage composition according to the first or second aspect of the present invention may comprise Reb M as the sole low caloric sweetener component. The beverage composition may also comprise other sweetening components such as other steviol sweeteners. Non-limiting examples of steviol sweeteners include Reb A, Reb B, Reb C, Reb D, Reb E, Reb F, Reb I, Reb H, Reb L, Reb K, Reb J, Reb M, Reb N, Reb O, dulcoside A, dulcoside B, stevioside, steviolbioside, rubusoside. Preferably, Reb M is the only steviol sweetening component in the beverage.

In an embodiment of the first aspect of the invention, Reb M and HFCS may be the only sweeteners present in the composition.

In an embodiment of the second aspect of the invention, sodium (preferably in the form of sodium chloride) is the sole electrolyte present in the composition.

The beverage according to the first aspect may also comprise additional carbohydrate based sweeteners, non-limiting examples include fructose, glucose, sucrose, erythritol, maltitol, lactitol, sorbitol, mannitol, xylitol, tagatose, trehalose, galactose, rhamnose, cyclodextrin, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose, galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, maltooligosaccharides (maltotriose, maltotetraose, maltopentaose, maltohexaose, maltoheptaose), dextrins, lactulose, melibiose, raffinose, rhamnose, ribose, isomerized liquid sugars, coupling sugars, soybean oligosaccharides, glucose syrup and combinations thereof. D- or L-configurations can be used when applicable.

The beverage according to the second aspect may also comprise additional carbohydrate based sweeteners, non-limiting examples include sucrose, fructose, glucose, erythritol, maltitol, lactitol, sorbitol, mannitol, xylitol, tagatose, trehalose, galactose, rhamnose, cyclodextrin, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose, galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, maltooligosaccharides (maltotriose, maltotetraose, maltopentaose, maltohexaose, maltoheptaose), dextrins, lactulose, melibiose, raffinose, rhamnose, ribose, isomerized liquid sugars, high fructose corn syrup (HFCS e.g., HFCS55, HFCS42, or HFCS90), coupling sugars, soybean oligosaccharides, glucose syrup and combinations thereof. D- or L-configurations can be used when applicable.

Additional sweetening components may be selected from natural high potency sweeteners such as mogroside IV, mogroside V, Luo Han Guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

Additional sweetening components may be synthetic sweeteners. As used herein, the phrase “synthetic sweetener” refers to any composition which is not found naturally in nature and characteristically has a sweetness potency greater than sucrose, fructose, or glucose, yet has less calories. Non-limiting examples of synthetic high-potency sweeteners suitable for embodiments of this disclosure include sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

Any of the additional sweetening components, either carbohydrate sweeteners, natural high potency sweeteners or synthetic sweeteners may be present in the beverage composition in a concentration from about 0.3 ppm to about 3,500 ppm.

The amount of sucrose in a reference solution may be described in degrees Brix (° Bx). One degree Brix is 1 gram of sucrose in 100 grams of aqueous solution and represents the strength of the solution as percentage by weight (% wt).

In one embodiment of the first aspect of the invention, a beverage composition contains Reb M and HFCS in an amount effective to provide a total sweetness equivalent from about 0.5 to 15° Bx of sucrose when present in a sweetened composition, such as, for example, from about 5 to about 11 degrees Brix, from about 4 to about 7 degrees Brix, or about 5 degrees Brix. In another embodiment, Reb M and HFCS are present in an amount effective to provide sweetness equivalent to about 10° Bx.

In an embodiment of the second aspect of the invention, a beverage composition contains Reb M in an amount effective to provide a total sweetness equivalent from about 0.5 to 15° Bx of sucrose when present in a sweetened composition, such as, for example, from about 5 to about 11 degrees Brix, from about 4 to about 7 degrees Brix, or about 5 degrees Brix. In another embodiment, Reb M is present in an amount effective to provide sweetness equivalent to about 5° Bx.

In an embodiment of the second aspect of the invention, a beverage composition contains Reb M and Reb D in an amount effective to provide a total sweetness equivalent from about 0.5 to 15° Bx of sucrose when present in a sweetened composition, such as, for example, from about 5 to about 11 degrees Brix, from about 4 to about 7 degrees Brix, or about 5 degrees Brix. In another embodiment, Reb M and Reb D are present in an amount effective to provide sweetness equivalent to about 10° Bx.

In various embodiments of the present invention the total sweetness of the beverage composition is equivalent to 0.5 to 15 degrees Brix, 2 to 14 degrees Brix, 3 to 13 degrees Brix, 4 to 12 degrees Brix, 5 to 11 degrees Brix, 6 to 10 degrees Brix, or 9 to 10 degrees Brix. Most preferably the total sweetness of the beverage composition is equivalent to about 10 degrees Brix.

The term “about” as used herein indicates that a margin of +/−10% is applicable to the stated value.

In addition to Reb M the beverage compositions of the first and second aspects of the invention can optionally include further additives, detailed herein below. In some embodiments, the sweetener composition contains additives such as, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers and combinations thereof. In some embodiments, the additives act to improve the temporal and flavor profile of the sweetener to provide a beverage composition with excellent taste properties.

In a preferred embodiment the beverage may also comprise cinnamaldehyde, caffeine, caramel colouring and/or phosphoric acid

The beverage compositions which are suitable for the present invention include a ready-to-drink beverage, a beverage concentrate, a beverage syrup, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, milk beverages, coffee containing milk components, café au lait, milk tea, fruit milk beverages, beverages containing cereal extracts, smoothies and combinations thereof.

The beverages of the present invention may be a beverage composition concentrate. As used herein the term “beverage composition concentrate” also refers to “beverage syrup”. Beverage composition concentrates and beverage syrups are prepared with an initial volume of liquid (e.g. water) and the desired beverage ingredients. These products are more concentrated than a ready to drink beverage. A ready to drink beverage can be prepared from a concentrate or syrup by adding further volumes of liquid. A beverage concentrate may be from 3 to 15 fold more concentrated, or from 5 to 15 fold more concentrated, or from 8 to 12 fold more concentrated, or from 9 to 11 fold more concentrated than the ready-to-drink beverage.

In order produce a ready to drink beverage from the beverage composition concentrate additional liquid is required to dilute the concentrate. Suitable liquids include water, carbonated water deionized water, distilled water, reverse osmosis water, carbon-treated water, purified water, demineralized water. Wherein carbonated water is used the water may comprise CO₂ at a gas pressure from 1.0-3.5 kg/m³. Preferably the CO₂ is at a gas pressure from 1.5-3.0 kg/m³, more preferably the CO₂ is at a gas pressure from 2.0-3.0 kg/m³.

In another embodiment, wherein carbonated water is used the water may comprise CO₂ at a gas pressure from 1.0-3.5 kgf/cm². Preferably the CO₂ is at a gas pressure from 1.5-3.0 kgf/cm², more preferably the CO₂ is at a gas pressure from 2.0-3.0 kgf/cm².

In an embodiment of the first or second aspects of the invention the beverage is a low-calorie beverage composition or a reduced calorie beverage composition. A low-calorie beverage composition may have less than 75 kcal per 100 mL, less than 60 kcal per 100 mL, less than 50 kcal per 100 mL, less than 40 kcal per 100 mL, less than 30 kcal per 100 mL, less than 20 kcal per 100 mL. Wherein the beverage composition is a beverage composition concentrate, the ready-to-drink beverage composition that is produced upon diluting the concentrate may be a low calorie beverage.

The present inventors have surprisingly shown that beverage compositions comprising Reb M are more effective at relieving and maintaining this thirst relief than beverage compositions comprising Reb A or HFCS alone. They have also shown that Reb M can be combined with HFCS to produce a beverage with improved thirst-quenching properties. As such a third aspect of the invention is a beverage according to the first or second aspects for use in maintaining thirst relief.

In an embodiment of the third aspect of the invention the thirst relief is maintained over 30 to 150 minutes, 30 to 120 minutes, 30 to 90 minutes, 30 to 60 minutes, to 45 minutes, 45 to 150 minutes, 45 to 120 minutes, 45 to 90 minutes, 45 to 60 minutes, 60 to 150 minutes, 60 to 120 minutes, 60 to 90 minutes, 90 to 150 minutes, 90 to 120 minutes, or 120 to 150 minutes.

### EXAMPLES

### Example 1

In order to assess the effect of HFCS, Reb A and Reb M containing beverages on thirst a consumer test protocol was performed. 99 consumers were recruited to complete the testing. 33% were male and 66% were female. Participants were selected with a broad age range across 18-45 years and were all regular consumers of sparkling soft drinks. Participant had no food allergies, health problems, and were not pregnant or breastfeeding.

The experimental methodology used sequential monadic presentation of samples in randomised balanced order. Participants were asked not to eat or drink for 2 hours before their visit. They drank the drink at the start of the session and then answered questions about their level of thirst, before drinking, immediately after drinking, after half an hour, one hour and two hours. The questionnaire was completed by respondents on paper.

The participants also assessed the beverage in terms of how much they liked the beverage, the sweetness level and bitterness level, this data was analysed use ANOVA software.

Changes in thirst level between time points were calculated and confidence intervals reported. β-values were calculated for comparisons between time points and baseline. Average thirst for each time-point and change in thirst were charted.

The samples that were analysed were;

13.3% (13.3 g/100 g) HFCS

0.05% Reb A

5.3% (5.3 g/100 g) HFCS and 0.03% Reb A

8.0% (8.0 g/100 g) HFCS and 0.02% Reb A

0.05% Reb M

5.3% (5.3 g/100 g) HFCS and 0.03% Reb M

8.0% (8.0 g/100 g) HFCS and 0.02% Reb M

Beverages were prepared comprising the above components in aqueous phosphate buffer at pH 2.52 (+/−0.02). All ingredients were food grade. HFCS 55 was used. All beverages were chilled before use. The beverage samples were designed to have an equivalent sweetness level of 10° Bx.

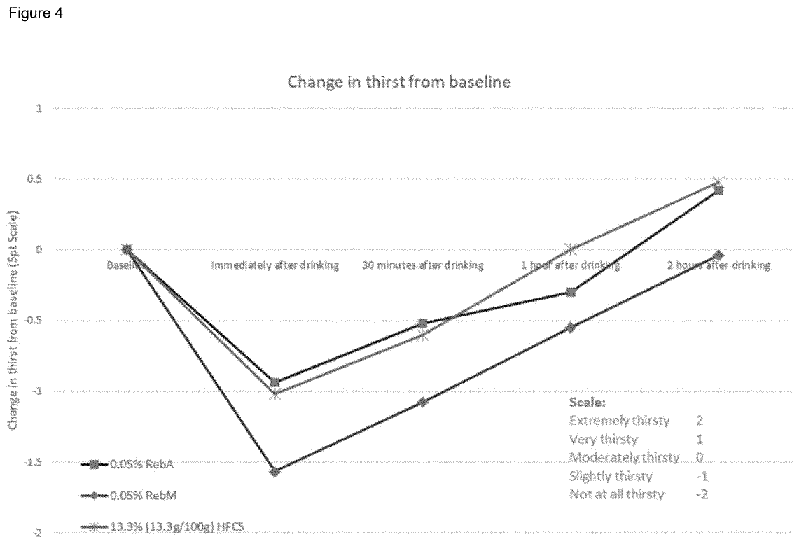

The data shown in FIG. 4 demonstrates that the 0.05% Reb A sample and 13.3% HFCS sample quenched the consumers thirst immediately after drinking. However, the 0.05% Reb M sample quenched the thirst significantly more, immediately after drinking than either the Reb A or HFCS samples. The data was processed using ANOVA software and the difference between the Reb M sample and the Reb A/HFCS samples had a p value of <0.05. Further, comparison of the samples two hours after drinking shows that both the 13.3% HFCS and 0.05% Reb A resulted in a thirst that was above the original baseline. This indicates that consumers were thirstier that they had been at the beginning of the experiment. In comparison, two hours after drinking the 0.05% Reb M sample, the level of thirst returned to baseline.

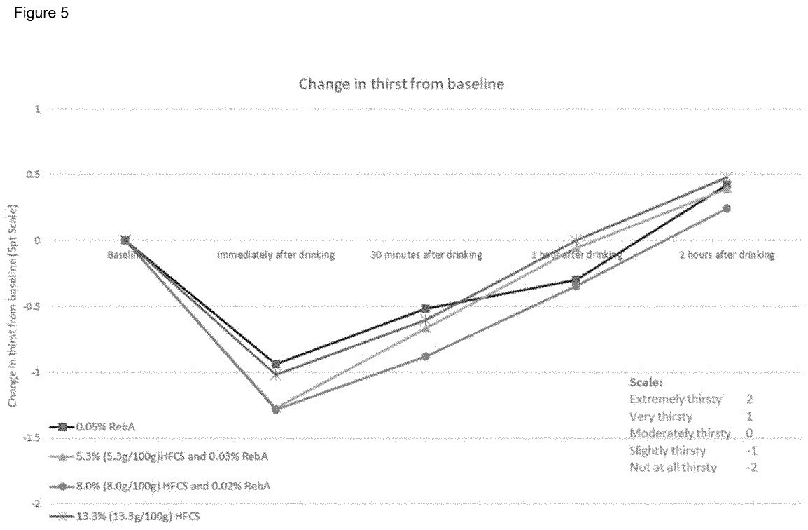

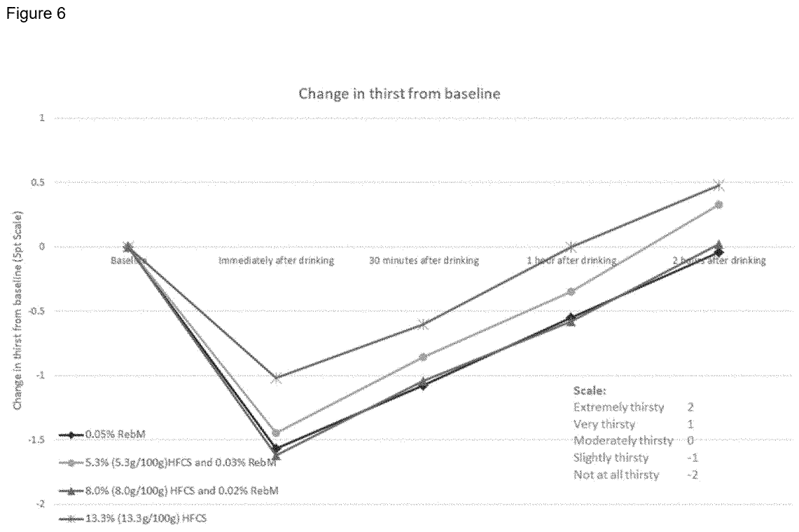

The data shown in FIG. 5 shows the effect on thirst of samples which combine both HFCS and Reb A. The combination samples result in a small increase in the thirst quenching effect compared to either Reb A or HFCS alone. However, the improvement is not significant and after two hours the level of thirst has raised above the baseline. FIG. 6 shows that combination of HFCS and Reb M can improve the level of thirst quenching. Surprisingly the beverage sample with 8% HFCS and 0.02% Reb M has a significant improvement in the reduction in thirst immediately after drinking. Two hours after drinking the 8% HFCS and 0.02% Reb M the thirst level had come back to baseline.

The data presented in FIGS. 4 to 6 has been normalised to a baseline value of 0.

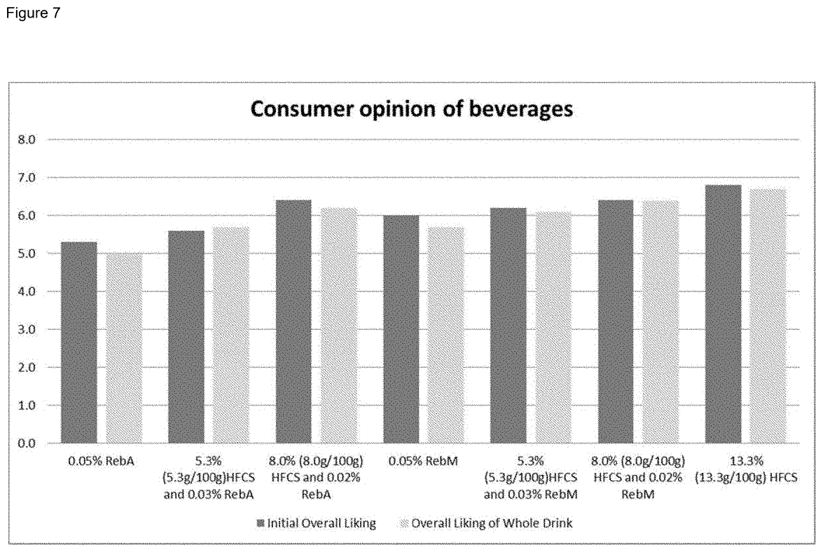

This data demonstrates the Reb M containing beverages have an improved thirst quenching effect that is maintained over a longer period after drinking than beverages containing either Reb A or HFCS or combinations. Consumers were also asked to assess the beverages in terms of taste. This is shown in FIG. 7 and shows that blending of Reb M with HFCS did not negatively impact the overall taste of the beverages.

### Example 2

Beverages comprising Reb M were found to be particularly thirst quenching. Therefore, this sweetener may be particular beneficial in sports drinks. In order to determine whether common components of sports drinks such as electrolytes may affect the thirst quenching effect, a further round of experiments was carried out wherein the beverages contained additional sodium.

The experimental protocol was performed as described in Example 1. The samples that were analysed were;

13.3% (13.3 g/100 g) HFCS+50 mg/100 mL sodium

0.05% Reb A+50 mg/100 mL sodium

0.05% Reb M+50 mg/100 mL sodium

Beverages were prepared comprising the above components in aqueous phosphate buffer at pH 2.52 (+1-0.02). All ingredients were food grade. HFCS 55 was used. All beverages were chilled before use. The beverage samples were designed to have an equivalent sweetness level of 10° Bx.

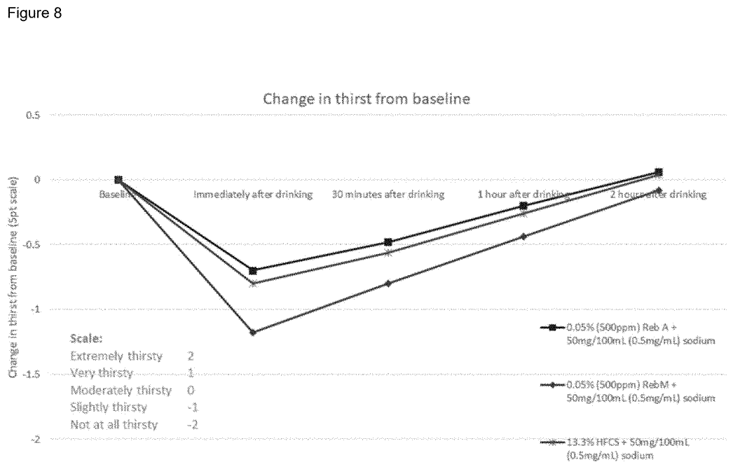

The data shown in FIG. 8 shows the effect on thirst of samples which contain Reb M, HFCS and Reb A each in combination with sodium. The beverage samples show the same tread as the samples without sodium. The 0.05% Reb A+sodium sample and 13.3% HFCS+sodium sample quenched the consumers thirst immediately after drinking. However, the 0.05% Reb M+sodium sample quenched the thirst significantly more, immediately after drinking than either the Reb A or HFCS samples. As such the improved thirst quenching effect of Reb M is not negatively impacted by the presence of electrolytes such as sodium. As such it is an ideal sweetener for use in sports drinks.

1. A beverage composition comprising Reb M in a concentration from 150 ppm to 400 ppm and HFCS in an amount from 2.0 to 10.0 wt % based on the total weight of the beverage composition, wherein the weight ratio of Reb M:HFCS is from 1:50 to 1:660.

2. The beverage composition of claim 1, wherein the HFCS is present in an amount from 2.0 to 8.0% and wherein the weight ratio of Reb M:HFCS is from 1:50 to 1:533.

3. The beverage composition of claim 1, wherein the HFCS is present in an amount from 4.0 to 8.0% and wherein the weight ratio of Reb M:HFCS is from 1:100 to 1:533.

4. A beverage composition comprising Reb M in a concentration from 100 to 500 ppm and sodium at a concentration from 20 to 70 mg/100 mL and wherein the pH is from pH 2 to 4.

5. The beverage composition of claim 4, wherein the beverage is a sports chink.

6. The beverage composition of claim 4, wherein the sodium is present in an amount from 35 to 55 mg/100 mL.

7. The beverage composition of claim 1, wherein the beverage comprises less than 50 kcal per 100 mL.

8. The beverage composition of claim 1, wherein the pH is from pH 2.5 to 3.5.

9. The beverage composition of claim 1, further comprising a sweetener selected from the group consisting of Reb A, Reb B, Reb C, Reb D, Reb E, stevioside, mogroside V, sucrose, HCFS, aspartame, saccharine, acesulfame K, erythritol and combinations thereof.

10. The beverage composition of claim 1, further comprising caffeine, cinnamaldehyde, phosphoric acid or caramel coloring.

11. The beverage composition of claim 1, wherein the total sweetness of the beverage is from 5 to 15 degrees Brix.

12. The beverage composition of claim 1, wherein Reb M and HFCS are the sole sweeteners present in the composition.

13. The beverage composition of claim 1, wherein Reb M is the sole sweetener present in the composition.

14. The A-beverage composition of claim 1 for use in achieving and/or maintaining thirst relief.

15. The beverage composition for use according to claim 14, wherein the thirst relief is maintained from 30 minutes to 150 minutes.
